(19) United States
(12) Patent Application Publication
(10) Pub. No.: US 2018/0153144 A1
(43) Pub. Date: Jun. 7, 2018

(54) SYSTEM AND METHOD FOR MAINTAINING THE HEALTH OF CAPTIVE FISH IN A MOBILE ENVIRONMENT

(71) Applicant: Donald J Baker, Poulsbo, WA (US)

(72) Inventor: Donald J Baker, Poulsbo, WA (US)

(21) Appl. No.: 15/872,919

(22) Filed: Jan. 16, 2018

Related U.S. Application Data
(63) Continuation of application No. 15/644,075, filed on Jul. 7, 2017, now abandoned.
Application No. 15/644,075 is a continuation-in-part of application No. 14/289,578, filed on May 28, 2014, now Pat. No. 9,801,361.
(60) Provisional application No. 61/828,080, filed on May 28, 2013.

(51) Int. Cl. A01K 63/02; A01K 63/06; A01K 63/04

(52) U.S. Cl. CPC A01K 63/02; A01K 63/04; A01K 63/065

(57) ABSTRACT

A system for maintaining the health of captive fish in a mobile environment, comprising a live well for containing fish in a fluid medium, a plurality of thermoelectric coolers affixed to the live well, and a live well controller for controlling a direct current applied to the thermoelectric coolers, and a method for maintaining a consistent temperature comprising the steps of setting an initial temperature, applying a current to thermoelectric coolers, reading a new temperature, and adjusting the current based at least in part on the new temperature reading.

### CROSS-REFERENCE TO RELATED APPLICATIONS

This application is a continuation of U.S. patent application Ser. No. 15/644,075, entitled “SYSTEM AND METHOD FOR MAINTAINING THE HEALTH OF CAPTIVE FISH IN A MOBILE ENVIRONMENT”, filed on Jul. 7, 2017, which is a continuation-in-part of U.S. patent application Ser. No. 14/289,578, entitled “SYSTEM AND METHOD FOR MAINTAINING THE HEALTH OF CAPTIVE FISH IN A MOBILE ENVIRONMENT”, filed on May 28, 2014, now issued as U.S. Pat. No. 9,801,361 on May 28, 2014, which claims benefit of, and priority to, U.S. provisional patent application 61/828,080, entitled “METHOD AND APPARATUS FOR HEALTHY CONTAINMENT OF LIVE FISH”, filed on May 28, 2013, the entire specification of which is incorporated herein by reference in its entirety.

### BACKGROUND OF THE INVENTION

### Field of the Art

The disclosure relates to the field of fishing equipment, and more particularly to the field of maintaining the health of live fish in a captive, mobile environment.

### Discussion of the State of the Art

The sport of fishing involves a number of technologies designed to keep fish healthy until needed. In most cases, the equipment utilized for live bait is often the same equipment utilized for the holding of caught fish though the actual containment areas will be separated from one another.

The technology in use today for preserving the health of fish while fishing commonly involves the use of a tank or live well of some sort through which water is re-circulated, the temperature is modulated as necessary and oxygenation of the water occurs through the introduction of fresh water or aeration of the tank water. All three of these things (water temperature, oxygenation and water cleanliness), work together to help keep the contained fish healthy.

Re-circulation of water through the live well helps to maintain the proper level of oxygen. Water being returned to the live well via the re-circulation pump is gently sprayed into the tank thus allowing the returning water to absorb oxygen prior to landing in the live well. This re-circulation process also brings about the need for temperature modulation.

Water in any kind of live well will change temperature through simple absorption of the heat or cold in the environment. Aeration of the re-circulated water being returned to the live well will lower the temperature of the water. The ideal design of a live well is for the water temp in the tank to match as closely as possible, the water temperature in the fish's natural habitat. Re-circulating the live well water provides the opportunity to expose the water to chilled pipes or warmed pipes and is frequently the method of varying the temperature of the water.

Thus we have a system in which all three requirements must be a part of any live well for fish. The challenge is finding a way to deliver each of the three requirements in which meeting any one of the requirements has a minimum impact on the other two requirements.

Today, the common method for varying the temperature of the water in the live well is to introduce cooler water from melting ice. While this does indeed lower the water temperature, the amount of ice needed for a full day of fishing on a lake is more than most boats can carry thus fishing boats must return to the docks to replenish ice stores on a regular basis. The round trip from the fishing spot to the docks and back costs a significant amount of money in terms of fishing time lost, gas to transit back and forth and increased boat weight.

The issue of oxygenation of the live well's water is often addressed through the frequency of water circulation. The most common method of oxygenation of the water is to spray the water back into the live well. Spraying has no mechanical parts beyond the circulation pump and is not prone to failure. Spraying does alter the water temperature and depending upon the difference between the ambient air and the desired temperature of the water, additional water cooling may be needed to counter the effects of heat being absorbed by the water from the ambient air. The common method for addressing the rising temperature of the water in the live well is to add ice water to the tank. As described earlier, using ice to cool the water only works when you have ice available.

There are a variety of ways in which these three requirements have been addressed. For example, the use of a radiator through which the water in the live well is passed in order to lower the temperature. While this approach has merit, it relies on filtered water to prevent the clogging of the tiny capillaries located in the radiator. Lake water and organic fish material are likely to bring about such a clogging of the radiator over time. In addition, a radiator is good for cooling but has no ability to heat water should that be necessary.

A similar problem is found when looking at approaches involving a recirculating water system that combines aeration along with cooling to help create a healthful tank environment. This approach also has merit but relies heavily on a tank of ice in order to have cooled coils over which the tank water can pass in order to be cooled. This brings the general problem of ice consumption into the picture thus solving the temperature problem but not addressing the ice problem.

What is needed is a means of addressing all three of the requirements without the use of ice, without mechanical circulation systems that can clog and without having wide swings in water temperature that affect the health of the fish. Such a system ought to be able to be delivered in a variety of forms including being fitted into existing holding tanks in boats, incorporated into new holding tanks in boats and as a stand-alone holding tank that has no reliance on a boat's fittings.

### SUMMARY OF THE INVENTION

Accordingly, the inventor has conceived and reduced to practice, in a preferred embodiment of the invention, a system and method for maintaining the health of fish in a mobile captive environment (such as a fishing vessel), without the use of ice or the risks of clogging, and that may be used to maintain an ideal temperature with minimal fluctuation.

According to a preferred embodiment of the invention, a system for healthy containment of live fish comprising a live well for containing live fish in a fluid medium (such as lake water from the habitat where the fish were found), a plurality of thermoelectric coolers connected to a direct current (DC) source (such as a battery, generator, or other suitable source of direct electric current), and a thermostatically-controlled rheostat that may automatically vary current to the thermoelectric coolers according to a predefined or configurable setting, is disclosed. According to the embodiment, a plurality of thermoelectric coolers may be placed in the fluid medium containing live fish, and a rheostat may be used such that a user (i.e., a fisherman) may select a desired temperature or range and the rheostat will automatically vary the current flow to the thermoelectric coolers based on thermostat feedback from the fluid medium, such that a consistent temperature is maintained automatically.

This invention introduces the technology of thermoelectric coolers to the fishing industry. Thermoelectric coolers utilize the Peltier Effect to create a heat pump. The thermoelectric cooler utilizes a DC current to cause electrons to flow between a heat source and a heat sink. The direction of the current flow determines which side of the thermoelectric cooler will act as heat sink (i.e., extracts heat from its surface environment), and which side will act as heat source (i.e., inject heat into its surface environment). That is, reversal of polarity will cause heat to flow in the opposite direction. Thus we have cooling side and a heating side whose positions can be reversed through a change of direction of the DC current.

The thermoelectric cooler can also vary the temperature of the heat source and heat sink through varying the strength of the voltage being used. The stronger the current, the higher the temperature differential between the two sides of the thermoelectric cooler.

Through the introduction of thermoelectric coolers to the live well, the temperature of the water in the tank can be varied by changes to the direction of current and strength of current flowing through the thermoelectric cooler.

As the thermoelectric cooler has no moving parts and no tubes, there is no possibility of clogging or damage from the circulating water. As live wells are made in differing sizes, the number of thermoelectric coolers introduced to a given tank can be matched to the water volume and speed with which temperature changes are desired.

Introduction of a thermostatically-controlled rheostat along with the thermoelectric cooler would allow the fisherman to select the desired temperature of the holding tank and let the rheostat vary the current going to the thermoelectric cooler in order to vary the water temperature.

Utilizing thermoelectric coolers in the holding tank eliminates the need for ice and the cost of replenishment that it brings. The thermoelectric coolers also address the need for a system that has as few moving parts as possible. Moving parts break. Thermoelectric coolers have no moving parts thus there is nothing to break down during use. Lastly, the small amount of electrical current needed to power the thermoelectric coolers can be supplied by batteries; themselves recharged via solar panels or other recharging methods if necessary.

In another embodiment of the invention, an additional thermostat may be utilized that is placed in surrounding lake water (i.e., outside of a fishing vessel or on the exterior of the hull below the waterline so it remains submerged), such that no manual input is needed and the rheostat uses the external thermostat as feedback to control the temperature of the fluid medium in the live well, such that the temperature consistently matches that of the surrounding lake (i.e., the natural habitat of the fish in containment, which it may be reasonably assumed is an ideal environment to maintain their health).

In another preferred embodiment of the invention, a method for maintaining the health of live fish in containment, comprising the steps of selecting a temperature setting, optionally retrieving an initial temperature setting from a thermostat, applying a direct current to a thermoelectric cooler, receiving thermostat feedback on the results of the cooler operation, and adjusting the current based at least in part on the feedback, is disclosed. According to the embodiment, operation may continue in a looping fashion such that the current is continuously manipulated to maintain temperature based on feedback from a plurality of thermostats, and an initial setting may be either manually input by a user or retrieved from a thermostat (such as a thermostat placed on the outside of a vessel), interchangeably.

In another preferred embodiment of the invention, a system for healthy containment of live fish comprising a live well for containing live fish in a fluid medium (such as lake water from the habitat where the fish were found), a plurality of thermoelectric coolers connected to a direct current (DC) source (such as a battery, generator, or other suitable source of direct electric current), and a thermostatically-controlled rheostat that may automatically vary current to the thermoelectric coolers according to a predefined or configurable setting, is disclosed. According to the embodiment, a live well controller may perform functions similar to a rheostat as described previously, as well as provide additional control and monitoring by communicating with any of a plurality of connected hardware devices in a live well arrangement, such as temperature sensors, pH sensors, salinity sensors, heat exchangers, individual thermoelectric coolers, or any other such devices that may be utilized as a component of or accessory to a live well. Further according to the embodiment, a live well controller may communicate via a data communication network such as the Internet or similar packet-based network, and may receive input data from network-connected devices such as software products or services (for example, various cloud-based services) or mobile computing devices such as a personal computer or smartphone. A network-connected live well controller may also provide live well data to network-connected devices, such as for monitoring of live well conditions, sensor values, or device operation.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a side-view illustration of a live well.

FIG. 2 is a front view illustration of a heat exchanger tank with multiple thermoelectric coolers installed in the walls of the tank.

FIG. 3 is a depiction of the thermometric rheostat that monitors the water temperature in the live well and varies the water temperature via control of the current going to the thermoelectric coolers and the speed of the re-circulation pumps.

FIG. 4 is a method flow diagram illustrating an exemplary method for maintaining the health of captive fish in a mobile environment, according to a preferred embodiment of the invention.

FIG. 5 is an illustration of an arrangement of a live well utilizing a network-connected live well controller, according to a preferred embodiment of the invention.

FIG. 6 is an illustration of an exemplary software user interface operating on a mobile device for interaction with a network-connected live well controller, according to an embodiment of the invention.

FIG. 7 is a block diagram illustrating an exemplary hardware architecture of a computing device used in an embodiment of the invention.

FIG. 8 is a block diagram illustrating an exemplary logical architecture for a client device, according to an embodiment of the invention.

### DETAILED DESCRIPTION

The inventor has conceived, and reduced to practice, a system and method for maintaining the health of captive fish in a mobile environment.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

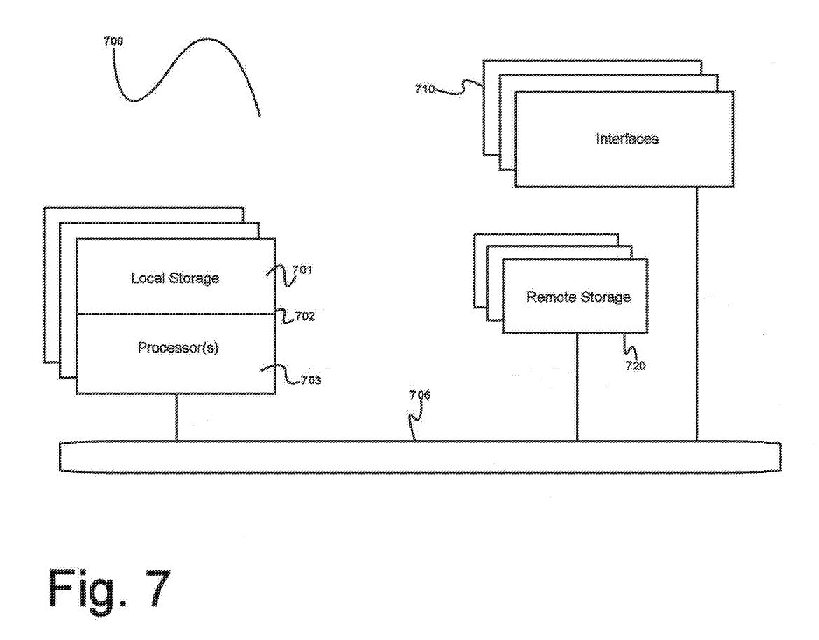

Referring now to FIG. 7, there is shown a block diagram depicting an exemplary computing device 700 suitable for implementing at least a portion of the features or functionalities disclosed herein. Computing device 700 may be, for example, any one of the computing machines listed in the previous paragraph, or indeed any other electronic device capable of executing software- or hardware-based instructions according to one or more programs stored in memory. Computing device 700 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 700 includes one or more central processing units (CPU) 702, one or more interfaces 710, and one or more busses 706 (such as a peripheral component interconnect (PCI) bus). When acting under the control of appropriate software or firmware, CPU 702 may be responsible for implementing specific functions associated with the functions of a specifically configured computing device or machine. For example, in at least one embodiment, a computing device 700 may be configured or designed to function as a server system utilizing CPU 702, local memory 701 and/or remote memory 720, and interface(s) 710. In at least one embodiment, CPU 702 may be caused to perform one or more of the different types of functions and/or operations under the control of software modules or components, which for example, may include an operating system and any appropriate applications software, drivers, and the like.

CPU 702 may include one or more processors 703 such as, for example, a processor from one of the Intel, ARM, Qualcomm, and AMD families of microprocessors. In some embodiments, processors 703 may include specially designed hardware such as application-specific integrated circuits (ASICs), electrically erasable programmable read-only memories (EEPROMs), field-programmable gate arrays (FPGAs), and so forth, for controlling operations of computing device 700. In a specific embodiment, a local memory 701 (such as non-volatile random access memory (RAM) and/or read-only memory (ROM), including for example one or more levels of cached memory) may also form part of CPU 702. However, there are many different ways in which memory may be coupled to system 700. Memory 701 may be used for a variety of purposes such as, for example, caching and/or storing data, programming instructions, and the like. It should be further appreciated that CPU 702 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 710 are provided as network interface cards (NICs). Generally, NICs control the sending and receiving of data packets over a computer network; other types of interfaces 710 may for example support other peripherals used with computing device 700. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 710 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 7 illustrates one specific architecture for a computing device 700 for implementing one or more of the inventions described herein, it is by no means the only device architecture on which at least a portion of the features and techniques described herein may be implemented. For example, architectures having one or any number of processors 703 may be used, and such processors 703 may be present in a single device or distributed among any number of devices. In one embodiment, a single processor 703 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 720 and local memory 701) configured to store data, program instructions for the general-purpose network operations, or other information relating to the functionality of the embodiments described herein (or any combinations of the above). Program instructions may control execution of or comprise an operating system and/or one or more applications, for example. Memory 720 or memories 701, 720 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

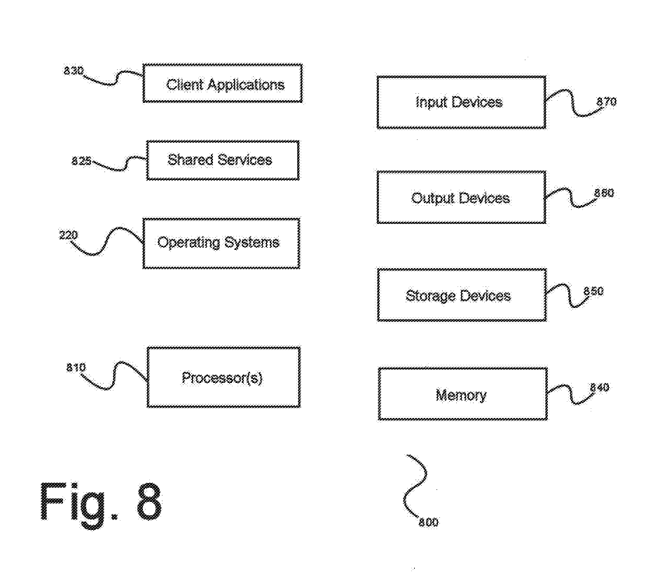

In some embodiments, systems according to the present invention may be implemented on a standalone computing system. Referring now to FIG. 8, there is shown a block diagram depicting a typical exemplary architecture of one or more embodiments or components thereof on a standalone computing system. Computing device 800 includes processors 810 that may run software that carry out one or more functions or applications of embodiments of the invention, such as for example a client application 830. Processors 810 may carry out computing instructions under control of an operating system 820 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 825 may be operable in system 800, and may be useful for providing common services to client applications 830. Services 825 may for example be WINDOWS™ services, user-space common services in a Linux environment, or any other type of common service architecture used with operating system 810. Input devices 870 may be of any type suitable for receiving user input, including for example a keyboard, touchscreen, microphone (for example, for voice input), mouse, touchpad, trackball, or any combination thereof. Output devices 860 may be of any type suitable for providing output to one or more users, whether remote or local to system 800, and may include for example one or more screens for visual output, speakers, printers, or any combination thereof. Memory 840 may be random-access memory having any structure and architecture known in the art, for use by processors 810, for example to run software. Storage devices 850 may be any magnetic, optical, mechanical, memristor, or electrical storage device for storage of data in digital form (such as those described above, referring to FIG. 7). Examples of storage devices 850 include flash memory, magnetic hard drive, CD-ROM, and/or the like.

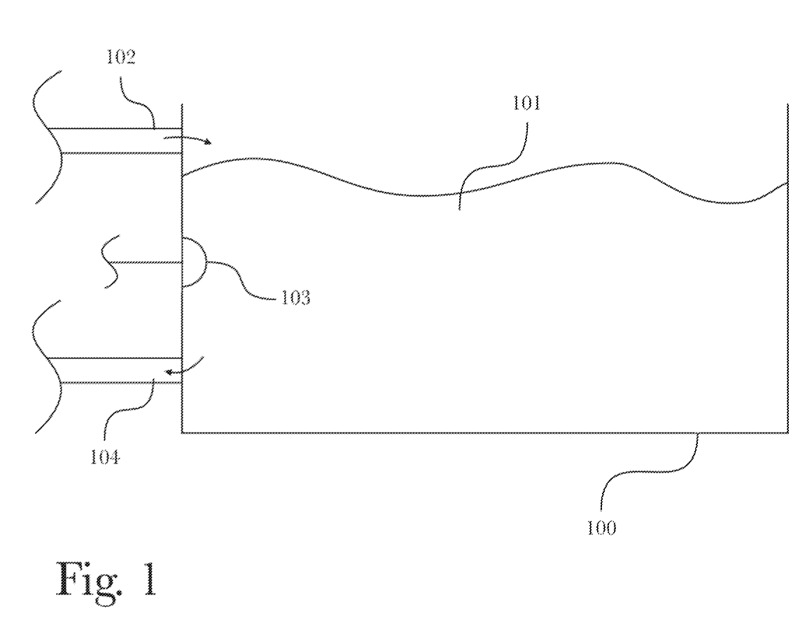

FIG. 1 is a side-view illustration of a live well 100. The live well 100 is a tank in which fish may be placed. Its size and shape will reflect the installation location be it fishing vessel or portable (such as hand-carried) form.

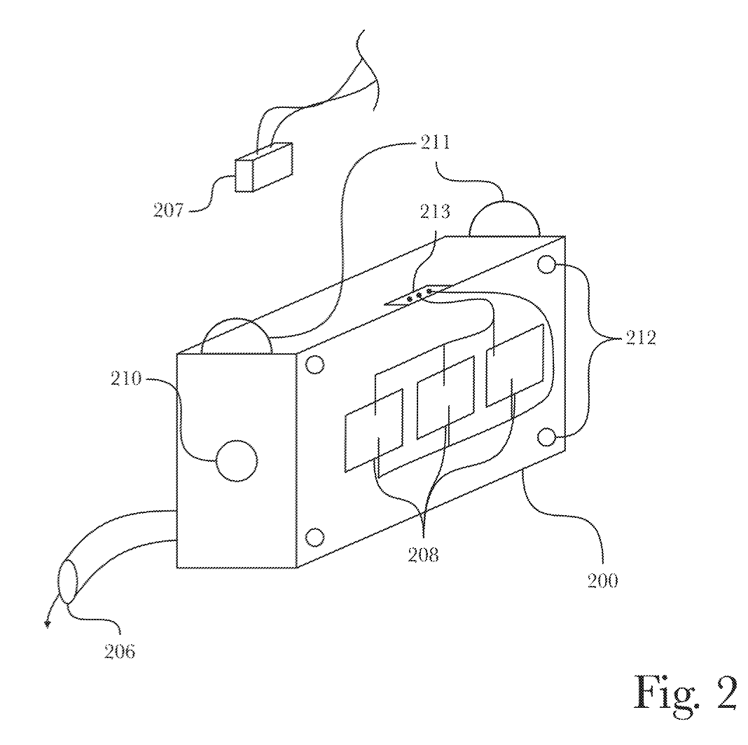

The live well may be filled with water 101 that may be treated to match the fish's natural habitat, salt water or fresh water. A hose may be connected to the live well 104 to allow water to be drawn from the live well and sent through a heat exchanger (as illustrated below, referring to FIG. 2) before being returned to the tank via the return feed hose 102. The temperature of the water in the live well may be continually measured by a temperature sensor 103.

FIG. 2 is a front view illustration of a heat exchanger tank 200 with multiple thermoelectric coolers installed in the walls of the tank. The heat exchanger 200 may receive water drawn from a live well 100 through an input tube 205. This water passes through the heat exchanger and may be returned to the live well 100 via the output tube 206.

Water flowing through the heat exchanger 200 may pass over a plurality of thermoelectric coolers 208. The size of the live well and the temperature difference between the live well and the ambient temperature may determine how many thermoelectric coolers will be installed into the heat exchanger. The thermoelectric coolers 208 may be electrically connected to a power cable 207 through which DC current is supplied from a source (such as a battery, engine, generator, or other appropriate source of direct electrical current). Varying the polarity (that is, the direction in which a current flows) of the DC current along with the voltage and amperage may allow the thermoelectric coolers to warm or cool the water as it passes by. The external sides of the thermoelectric coolers 208 may be exposed to body of water where fishing is occurring. The allows the large body of water to act as a heat sink for one side of the thermoelectric coolers, drawing heat away from the live well and fish within. The temperature of the water flowing out of the heat exchanger may be continually measured by a temperature sensor 210 located within the heat exchanger.

Monitoring the temperature of the water exiting the heat exchanger during re-circulation allows for various rates of temperature change in the live well. Small differences between the temperature in the live well versus the heat exchanger temperature would bring about a very gradual change in the live well water temperature. Larger differences would bring about more rapid changes in the live well water temperature. Various embodiments of manual override options to the thermoelectric rheostat would provide the flexibility to introduce personal preferences into the live well temperature management process.

The heat exchanger may be suspended from a fishing boat via mounting loops 211 or similar means of mounting or suspension. A plurality of bumpers 212 may be installed on the outside of the heat exchanger in order to ensure a sufficient gap exists between the heat exchanger 200 and the side of a fishing boat where the heat exchanger is suspended.

The electrical current used to operate the thermoelectric coolers and the wire carrying the temperature information from the temperature sensor 210 may be brought together at a termination point 213. This termination point should ideally be watertight, thus the connection will be sealed prior to initial usage.

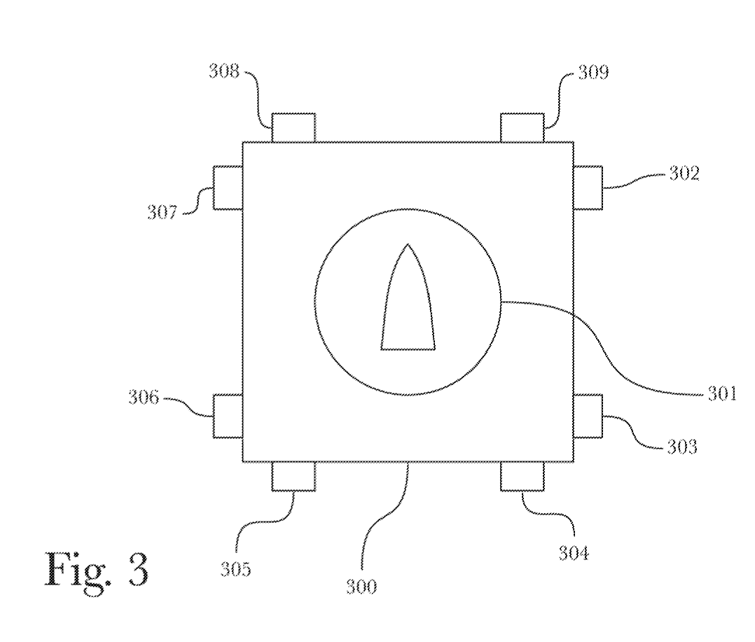

FIG. 3 is a depiction of a thermometric rheostat 300 that may monitor the water temperature in a live well 100 and may vary the water temperature via control of a current going to thermoelectric coolers 108 and may also vary the speed of re-circulation pumps (not shown). The temperature sensor 103 from a live well and the temperature sensor 210 from the heat exchanger may be connected to a thermometric rheostat 300 using connectors 308 & 309. The purpose of the thermoelectric rheostat may be to evaluate the temperature of the water in the live well and activate the re-circulation pumps and the heat exchanger to raise or lower the water temperature appropriately. The DC current may enter the thermoelectric rheostat at the positive and negative connectors 302 and 303. A re-circulation pump may be connected to terminals 304 & 305. The thermoelectric coolers may connect to the rheostat via terminals 307 & 306. A dial 301 on the front of the thermometric rheostat 300 may be used to set the desired temperature of the live well water manually if desired.

In normal operation, a temperature sensor 103 may provide signaling to a thermostatically controlled rheostat 300 indicating the current temperature in a live well 100. The rheostat 300 may interpret the signaling and determine the difference between the live well temperature and a target temperature. If it is determined that the water in the live well needs to be heated, a direct current of the appropriate polarity may be sent to thermoelectric coolers 208 and a circulation pump may be engaged. When the target temperature in the live well has been reached, the power may be shut off to both the re-circulation pump and the thermoelectric coolers. If the water in the live well needs to be cooled, the same process occurs with the exception that the polarity of the direct current going to the thermoelectric coolers 208 will be reversed, such that heat flows in the opposite direction (from the exterior environment into the live well, rather than drawn away from the live well and dissipated).

It may also be possible to set the thermoelectric rheostat to continually run the re-circulation pumps and only activate the thermoelectric coolers as the temperature sensors indicate a need, thus maintaining a continuous flow or circulation of water as may be desirable, while maintaining a consistent temperature rather than heating or cooling simultaneously to the circulation operation.

### Detailed Description of Exemplary Embodiments

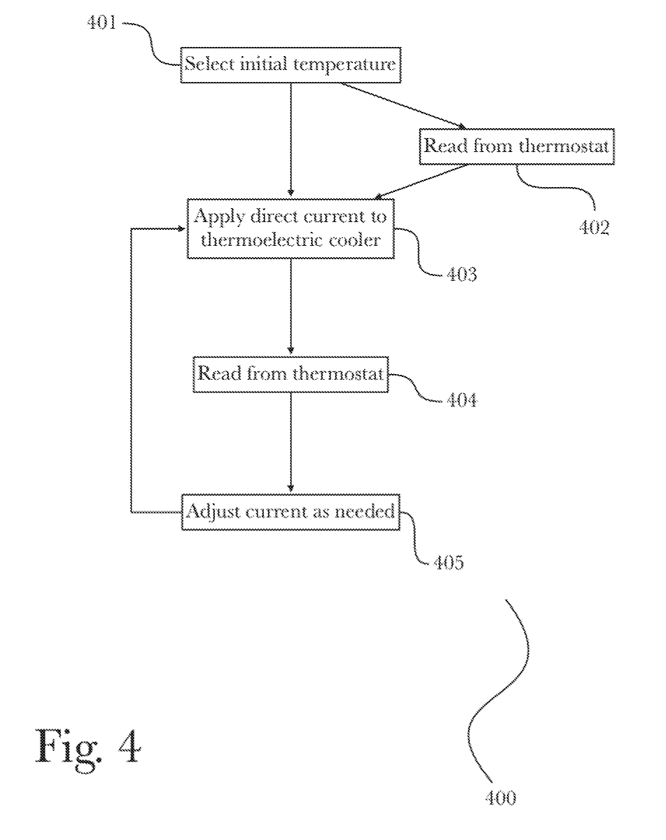

FIG. 4 is a method flow diagram illustrating an exemplary method for maintaining the health of captive fish in a mobile environment, according to a preferred embodiment of the invention. In an initial step 401, a temperature setting may be selected either manually such as by setting a dial or digital temperature selector, or automatically such as by optionally retrieving an initial temperature setting from a thermostat in an optional step 402. In a next step 403 a direct current may be applied to a thermoelectric cooler, such as a Peltier module. In a next step 404, feedback may be received from a thermostat such as to report on the results of the thermoelectric cooler operation (i.e., to indicate a temperature increase or decrease according to the operation mode of the cooler). In a final step 405, the current may then be adjusted (such as by varying the voltage or amperage, or reversing the current flow or polarity) based at least in part on the feedback, such as to alter the temperature further in an intelligent manner. According to the embodiment, operation may continue in a looping fashion such that the current is continuously manipulated to maintain temperature based on feedback from a plurality of thermostats, and an initial setting may be either manually input by a user or retrieved from a thermostat (such as a thermostat placed on the outside of a vessel), interchangeably.

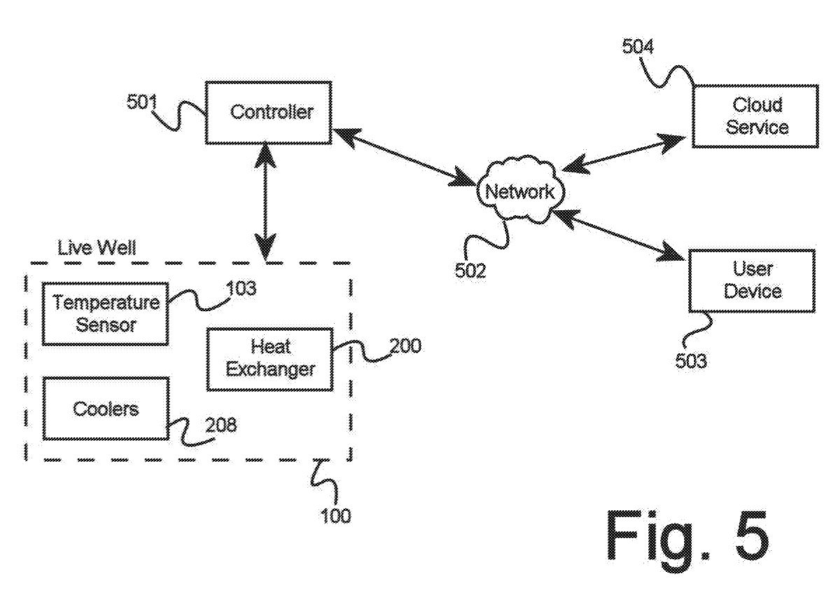

FIG. 5 is an illustration of an arrangement of a live well 100 utilizing a network-connected live well controller 501, according to a preferred embodiment of the invention. According to the embodiment, a live well controller 501 may be connected to, and in communication with, components of a live well 100, such as by a direct wired connection or through a networked or wireless connection communicating over airwaves (such as using WiFi or BLUETOOTH™, for example). Components of a live well 100 may include, but are not limited to, a plurality of temperature sensors 103, heat exchangers 200, or individual thermoelectric coolers 208, all of which are described above in greater detail with regard to their functionality (referring to FIGS. 1-3), but generally according to the embodiment a temperature sensor 103 may monitor a temperature of water (or other fluid) inside or outside a live well, a cooler 208 may apply thermoelectric heating or cooling techniques to alter a temperature of a fluid within a live well, and a heat exchanger 200 may comprise a number of thermoelectric coolers 208 and may direct the operation of such coolers 208 to regulate a temperature of a fluid being conducted through the heat exchanger 200. A live well controller 501 may communicate with such live well components, such as to receive information (for example, temperature readings from a temperature sensor 103) or to provide instruction for operation (for example, to provide a target temperature to a heat exchanger 200), such that a live well controller 501 may be used to interactively direct the operation of various live well components individually or in combination. In this manner, a controller 501 may provide similar functionality as that of a rheostat (described above, referring to FIG. 3), adjusting and regulating the operation of live well components to alter or maintain temperature of a contained fluid. Additionally, a live well controller 501 may provide further control beyond that of a rheostat, by utilizing additional sensors or other hardware components according to a particular arrangement of a live well 100; for example, salinity sensors may be utilized to monitor the salinity of seawater within a live well 100, or pH sensors to monitor acidity. In this manner it can be appreciated that the use of a controller according to the embodiment may provide increased feedback and control over a live well 100 that would not otherwise be possible in rheostat-based configurations or through manual control of live well components.

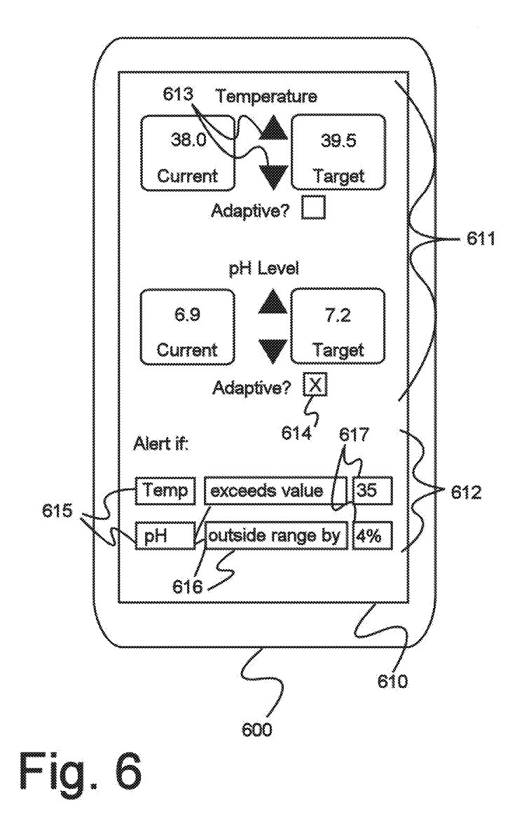

According to the embodiment, a live well controller 501 may communicate via a network 502 such as the Internet or a local area network (LAN), using any of a variety of suitable communication hardware or protocols such as (for example, but not limited to) WiFi, BLUETOOTH™, satellite, or cellular communication means. In this manner a live well controller 501 may connect to a variety of network-connected products or services, such as a plurality of cloud-based services 504, for example including data storage services (such as DROPBOX™ or GOOGLE DRIVE™), monitoring or automation services such as IFTTT™, or communication services such as email or short message service (SMS) notification systems. In this manner the functionality of a live well controller 501 may be further extended through interaction or integration with various external or third-party services, and also through the use of communication services such as SMS the operation of a live well controller 501 (and thus, the operation of a live well 100) may be more closely monitored by a user (for example, if a defined metric such as acidity or temperature exceeds a specified value or range, a notification or message could be sent to alert the user to take action). A live well controller 501 may also communicate with a user device 503, such as a smartphone or personal computer, for example to present data for user review or to receive user input to facilitate a degree of manual control. For example, a user may use a smartphone operating a software application that provides a reporting or interaction user interface, where they may review various input data from a live well 100 as collected and presented by a live well controller 501, such as the temperature, salinity, acidity, or fill level of a contained fluid within a live well 100. The user may also be presented with a variety of interactive interface elements or other suitable means for interaction, to configure or control the operation of a live well controller 501 manually, such as to define a preferred temperature range or set a fill level to maintain during operation, or to configure various notification alerts, or “trigger” values that should alert the user; for example, to alert the user immediately if a fluid temperature exceeds a certain value or if acidity varies beyond a target range. Various specific exemplary functions of such a software application are described below in greater detail, referring to FIG. 6. A further function of a live well controller may be the storage and reference of historical sensor or other data, for example to track conditions in a body of water over a period of several days or from one season or year to the next. Such historical data may then be used to more accurately control conditions within a live well, for example by making predictions based on historical trends and adjusting conditions in anticipation of environment changes in order to minimize any discrepancies between a contained fluid within a live well and an external environment.

In this manner, the use of a network-connected live well controller 501 may provide enhanced operation of a live well 100 through the use of network-enabled functions and automated behaviors, enabling a user to configure a live well with a fine level of control and then rely on a live well controller 501 to maintain a set configuration. Additionally, through the use of connected sensors and other live well hardware components (as described above), adaptive or learning behavior may be provided by a live well controller 501, wherein live well components (such as temperature sensors 103, heat exchangers 200, or other hardware devices) may be directed, controlled, or adjusted by a live well controller 501 based at least in part on received input data, and optionally based at least in part on configured parameters received from a user via a user device 503 such as defined temperature or acidity ranges (for example). It should be appreciated that various arrangements may use additional or alternate live well components or data parameters, thereby providing a variety of functionalities according to a particular arrangement or desired purpose (such as maintaining an ideal water environment within a live well 100 for the healthy containment of live fish). Additionally, it should be appreciated that various enhanced functions provided by a network-connected live well controller 501 may be utilized regardless of network connectivity; for example, in an arrangement for containment of live fish while fishing out on a body of water such as a lake, a user may connect to a live well controller 501 with a mobile device 503 and configure parameters or behaviors for operation. Then, while fishing on the body of water, network signal may be inconsistent, weak, or unavailable; in the case that a network connection is not available, a live well controller 501 may continue to operate according to a user's configuration settings, and may optionally maintain a LAN connection to the user's device 503 such as via BLUETOOTH™ or WiFi, for example to send the user notifications according to a particular configuration. In this manner a live well controller 501 and user device 503 may interact with one another regardless of the state of an external network connection, and when an external connection becomes available, a connection may be re-established to any configured cloud services 504 and any additional or enhanced functionality may then be utilized while a connection remains active. If an external connection is lost, operation may continue according to a “last known state”, or a set of configuration settings that were in use when a connection was lost. In this manner, operation may continue without interruption, and as network connections become available configuration settings such as behaviors or parameter values or ranges may be updated when possible, but in the absence of a network connection functionality is not lost.

FIG. 6 is an illustration of an exemplary software user interface 610 operating on a mobile device 600 for interaction with a network-connected live well controller, according to an embodiment of the invention. According to the embodiment, a user interface 610 may comprise interactive controls such as buttons, drop-down menus, lists, text boxes, or other interactive indicia for a user to (for example) configure desired values 611 for various measurable characteristics according to an arrangement of a live well (as described above, referring to FIG. 5), or to configure notifications or alerts 612 such as based on changes in monitored values. In an exemplary arrangement shown, controls 613 may be presented for a user to increase or decrease a desired metric value such as a temperature or pH level of a fluid within a live well (such as water being maintained in a specific manner for the healthy accommodation of fish, for example). By varying these values a user may be given control over the desired environment within a live well, according to the nature of a particular arrangement; for example, in an arrangement utilizing salinity sensors and means to add or remove dissolved salts from a contained fluid, controls may be given to alter a target salinity level within a live well. Additional controls 614 may be provided to choose whether or not to employ adaptive behavior, or automatic adjustments to target values based on sensor measurements. For example, in an arrangement of a live well for accommodating fish in an optimal environment within a live well while fishing, water may be drawn from a lake (or other body of water) to fill a live well. This water may vary significantly from water in other areas where fish may be caught, and it may be generally assumed that the water conditions where the fish were found are a desirable environment for the fish. Utilizing adaptive behavior, a live well controller may collect sensor data from the water outside a live well and adjust the conditions of the water inside the live well accordingly, to more closely match the surroundings and thereby provide a suitable environment for any fish that may be caught in that area. Without this adaptive behavior, water conditions within a live well may not be as precisely matched to those outside, and the quality of the water environment (and thus potentially the health of any contained fish) may be decreased.

Further according to the embodiment, controls 612 for configuring alerts and notifications may be provided so that a user may choose how they wish to be alerted to changes in conditions within a live well. Various configurations and combinations may be setup by a user using interactive indicia such as drop-down menus 615 with multiple options, for example to select what metric is being configured for notification according to a particular rule or condition. Additional menus 616 may be provided to configure the logic of a rule (such as “alert if the temperature exceeds this specific value”, or “alert if the pH is outside of this range”), and an input box 617 or similar user input means may be provided for a user to set a particular value or range of values for a given condition, such that upon meeting all the specified conditions of a particular rule, a notification may be sent. In this manner it may be appreciated that a wide degree of control and customizability may be granted to a user, so that they may configure the performance of and level of interaction with a live well according to their particular needs or preferences.

The skilled person will be aware of a range of possible modifications of the various embodiments described above. Accordingly, the present invention is defined by the claims and their equivalents.

What is claimed is:

1. A system for maintaining the health of captive fish in a mobile environment, comprising:
a live well;
a fluid medium;
a plurality of thermoelectric coolers; and
a live well controller;
wherein the live well is a container that holds the fluid medium;
wherein the thermoelectric coolers are affixed to the live well and receive a direct electric current; and
wherein the live well controller controls the direct electric current and thereby controls water temperature in the live well.

2. The system of claim 1, wherein the thermoelectric coolers are integral to the design of the live well.

3. The system of claim 1, wherein the thermoelectric coolers are removably affixed to the live well.

4. The system of claim 1, wherein the live well is affixed to the hull of a boat.

5. The system of claim 1, further comprising an internal sensor, wherein the internal sensor reads the fluid conditions of the fluid medium within the live well.

6. The system of claim 5, wherein the live well controller receives sensor data from the internal sensor, and alters the direct electric current based at least in part on the sensor data.

7. The system of claim 5, wherein the internal sensor is a thermometer.

8. The system of claim 5, wherein the internal sensor is a pH sensor.

9. The system of claim 5, further comprising an external sensor, wherein the external sensor reads the fluid conditions of an environment external to the live well.

10. The system of claim 9, wherein the live well controller receives sensor data from the external sensor, and alters the direct electric current based at least in part on the sensor data.

11. The system of claim 9, wherein the external sensor is a thermometer.

12. The system of claim 9, wherein the external sensor is a pH sensor.

13. The system of claim 9, wherein the external environment is a body of water.

14. The system of claim 9, wherein the live well controller continuously receives input data from the internal and external sensors, and further wherein the live well controller automatically alters the direct current based at least in part on received input data.

15. The system of claim 9, wherein the live well controller stores received sensor data in a memory and alters the direct current based at least in part on stored sensor data.

16. The system of claim 1, wherein the live well controller communicates via a data communication network.

17. The system of claim 16, wherein the live well controller receives input data from a network-connected input source.

18. The system of claim 16, wherein the live well controller alters the direct current based at least in part on the input data.

19. The system of claim 16, wherein the input source is a software application.

20. The system of claim 16, wherein the input source is a computing device.
